(19) United States
(12) Patent Application Publication
(10) Pub. No.: US 2008/0241626 A1
(43) Pub. Date: Oct. 2, 2008

(54) Polymer blend membranes for fuel cells and fuel cells comprising the same

(75) Inventors: Sung-Chul Kim, Daejeon (KR); Dong-Hwee Kim, Daegu (KR)

Correspondence Address: EDWARDS ANGELL PALMER & DODGE LLP, P.O. BOX 55874, BOSTON, MA, 02205, US

(73) Assignee: Korea Advanced Institute of Science and Technology, Daejeon (KR)

(21) Appl. No.: 11/800,205

(22) Filed: May 4, 2007

(30) Foreign Application Priority Data
Mar. 29, 2007 (KR) 10-2007-0031157

(51) Int. Cl. H01M 8/10; C08F 283/00

(52) U.S. Cl. 429/33; 525/535

(57) ABSTRACT

The present invention relates to polymer blend membranes of sulfonated and nonsulfonated polysulfones, methods for the preparation the membrane, and fuel cells comprising the same. The blend membranes can be obtained by varying drying condition and concentration of casting solution. The membranes have improved methanol barrier property, proton conductivity and membrane selectivity.

### CROSS-REFERENCE TO RELATED APPLICATION

The present application claims, under 35 U.S.C. §119, the benefit of Korean Patent Application No. 10-2007-0031157, filed Mar. 29, 2007, the entire contents of which are hereby incorporated by reference.

### BACKGROUND OF THE INVENTION

1. Technical Field

The present invention relates to a polymer blend membrane for a fuel cell, a method for preparing the membrane, and a fuel cell comprising the membrane. More particularly, the present invention relates to a polymer blend membrane the morphology of which is controlled so as to improve the overall efficiency and selectivity of the membrane by adjusting drying condition and concentration of casting solution, a method for preparing the membrane, and a fuel cell comprising the same.

2. Background Art

A fuel cell is an energy conversion system that converts chemical energy directly into electrical energy with higher efficiency and lower emission of pollutants than commercial internal combustion engines. The basic physical structure or building block of fuel cells consists of an electrolyte layer in contact with an anode and a cathode on either side thereof. In a typical fuel cell, a gaseous fuel flows continuously to the anode compartment and an oxidant (i.e., oxygen from air) flows continuously to the cathode compartment; the electrochemical reaction takes place at the electrodes to produce an electric current.

Fuel cells and batteries, although having similar components and characteristics, differ in several respects. A battery is an energy storage device. The maximum available energy is determined by the amount of chemical reactants stored within the battery itself. The battery will cease to produce electrical energy when the chemical reactants are consumed (i.e., discharged). In a secondary battery, the reactants are regenerated by recharging, which involves putting energy into the battery from an external source. Fuel cells, on the other hand, theoretically have the capability of producing electrical energy as long as the fuel and oxidant are supplied to the electrodes.

In direct methanol fuel cell (DMFC), the fuel, methanol, is oxidized at the anode surface, producing carbon dioxide and proton. The proton migrates through the polymer electrolyte membrane with fixed anionic charges. At the contact area of the cathode and the polymer electrolyte membrane, proton reacts with oxygen to produce water. Electricity can be generated through the external circuit by the flow of electron. Thus, polymer electrolyte membranes are required to have a high proton conductivity. The electrochemical reaction in the DMFC is represented by the following equations.

anode reaction: CH₃OH+H₂O→CO₂+6H⁺+6e⁻ 1.

cathode reaction: 1.5O₂+6H⁺+6e⁻→3H₂O 2.

overall reaction: CH₃OH+1.5O₂→2H₂O+CO₂ 3.

DMFC is considered to have the strongest potential for small sized devices such as portable electric appliances due to the low operating temperature, simple structure, and the easiness of the fuel handling. Unlike the other types of fuel cells which require hydrogen as the fuel sources, DMFC only requires liquid type methanol. DMFC system is easily initiated because of its low operating temperature. Furthermore, its simple structure facilitates easy fabrication; for example, auxiliary hydrogen producing or supplying devices such as a fuel vaporizer, complex humidification, and thermal management systems are not required. Also, fuel storage and supply are safe, since methanol is chemically stable and is used in a liquid state in the operating condition. The high energy density of methanol also facilitates application to portable devices, because the integration of various functions into one unit requires concentrated power density.

Practically, however, DMFC has a drawback in that part of the fuel (methanol) permeates through the membrane to the cathode side. This methanol crossover induces an unexpected drop in the open circuit voltage, thereby reducing the overall efficiency of the system.

Commercially available polymer electrolyte membranes are perfluorosulfonated copolymers such as Nafion® (DuPont), Flemion® (Asahi Glass), Aciplex® (Asahi chemical), and XUS® (Dow Chemical), and modified membranes such as BAM3G® (Ballard), which is a sulfonated polytrifluorostyrene membrane, and Gore select® (Gore), which is a PTFE reinforced Nafion membrane. Although these ion-exchange polymers are suitable as polymer electrolyte membranes in hydrogen fuel cells, they are not suitable for application to DMFCs because their methanol permeability is too high to maintain the operating voltage.

To provide a polymer membrane that has a substantially high proton conductivity and can solve the above-described problems associated with methanol crossover, a method for blending the proton conductive component and the methanol barrier component has been used as disclosed in, for example, U.S. Pat. Nos. 6,723,757, 5,599,638, and 6,194,474. The method, however, adjusts the blend ratio or the chemical structure of the component materials and thus cannot improve the membrane selectivity which is defined as proton conductivity divided by methanol permeability.

Another proposed method is to prepare a multi-layered membrane by dipping a membrane into different polymer solutions in series, as disclosed in, for example, U.S. Pat. No. 6,869,980. However, as this method requires a two-step process and the interfacial adhesion between the two layers is not strong, the layers are easy to delaminate from each other in the hydrated state.

There is thus a need for a new polymer membrane that has a substantially high proton conductivity and solves the problems associated with methanol crossover.

The information disclosed in this Background section is only for enhancement of understanding of the background of the invention and should not be taken as an acknowledgement or any form of suggestion that this information forms the prior art that is already known to a person skilled in the art.

### BRIEF SUMMARY OF THE INVENTION

The present invention has been made to provide a new polymer membrane that has a high proton conductivity and can solve the methanol crossover problems, a method for preparing the membrane, and a fuel cell comprising the membrane.

In one aspect, the present invention provides a polymer blend membrane comprising a highly sulfonated polysulfone copolymer and a nonsulfonated polysulfone copolymer. The morphology of the membrane is controlled by adjusting drying condition and the concentration of casting solution. For example, in a preferred embodiment, a co-continuous morphology of the membrane can be provided by freeze-drying at a low temperature. The co-continuous morphology provides a high proton conductivity and the presence of the neighboring nonsulfonated continuous phase restricts methanol crossover at a high temperature, thereby increasing membrane selectivity.

In another preferred embodiment, a two-layered morphology is provided by lowering the viscosity of the polymer solution and increasing the drying temperature. The two-layer structure may preferably contain the nonsulfonated component which forms the matrix in the upper layer facing the anode and the sulfonated and conducting component which forms the matrix in the lower layer facing the cathode, in which methanol permeation is effectively prevented due to the nonsulfonated polysulfone rich upper layer.

In a further aspect, the present invention provides a method for preparing the polymer blend membranes. The method comprises the steps of: (a) blending a highly sulfonated polysulfone copolymer and a nonsulfonated polysulfone copolymer in a solvent; (b) casting the solution; and (c) removing the solvent from the cast solution.

In another preferred embodiment, the method may further comprise the step of suppressing phase separation at early stage of spinodal decomposition. Preferably, the step of suppressing phase separation can be carried out by freeze-drying. In this embodiment, the removal of the solvent can be accelerated by using a solvent with low boiling point, increasing the viscosity of the solution, or lowering drying temperature.

In still another embodiment, the method may further comprise the step of maintaining phase separation until late stage of spinodal decomposition. Preferably, the removal of the solvent can be delayed by using a solvent with high boiling point, lowering the viscosity of the solution or increasing drying temperature.

In another aspect, fuel cells are provided that comprise a described polymer membrane.

Other aspects of the invention are discussed infra.

### BRIEF DESCRIPTION OF THE DRAWINGS

These, and other features and advantages of the invention, will become clear to those skilled in the art from the following detailed description of the preferred embodiments of the invention rendered in conjunction with the appended drawings in which:

FIG. 1 is a graph showing proton conductivity of polymer blend membranes according to a preferred embodiment of the present invention;

FIG. 2 is a graph showing methanol permeability of polymer blend membranes according to a preferred embodiment of the present invention;

FIG. 3 is a graph showing selectivity of polymer blend membranes according to a preferred embodiment of the present invention.

FIG. 4 is a graph comparing the proton conductivity of FIG. 1 with the selectivity of FIG. 3;

FIG. 5 is a graph comparing the methanol permeability of FIG. 2 with the membrane selectivity of FIG. 3;

FIG. 6 is a graph comparing the proton conductivity of FIG. 1 with the methanol permeability of FIG. 2;

FIG. 7 is scanning electron microscopy image of a polymer blend membrane with co-continuous morphology according to a preferred embodiment of the present invention; and

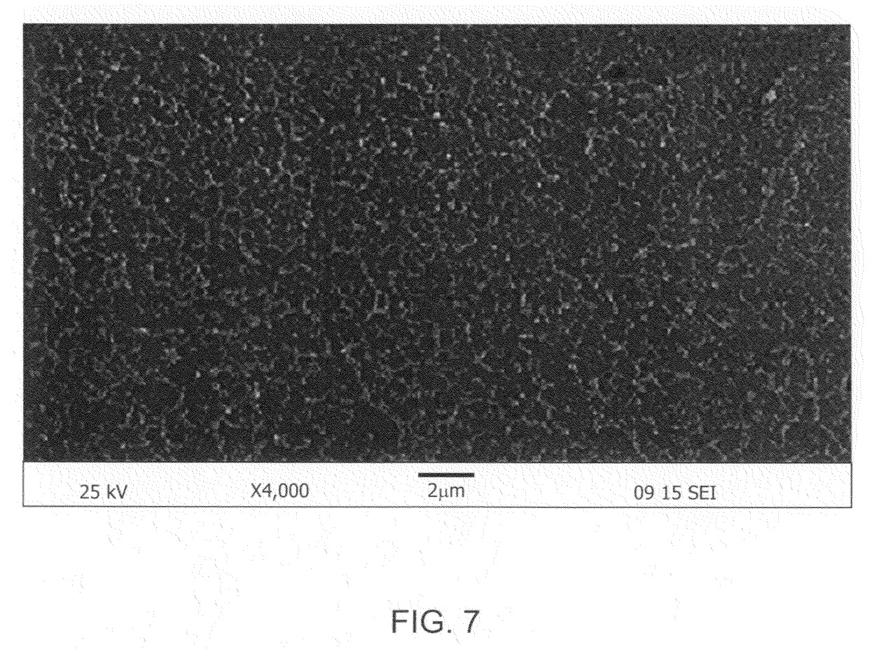

FIG. 8 is scanning electron microscopy image of a polymer blend membrane with two-layer morphology according to a preferred embodiment of the present invention;

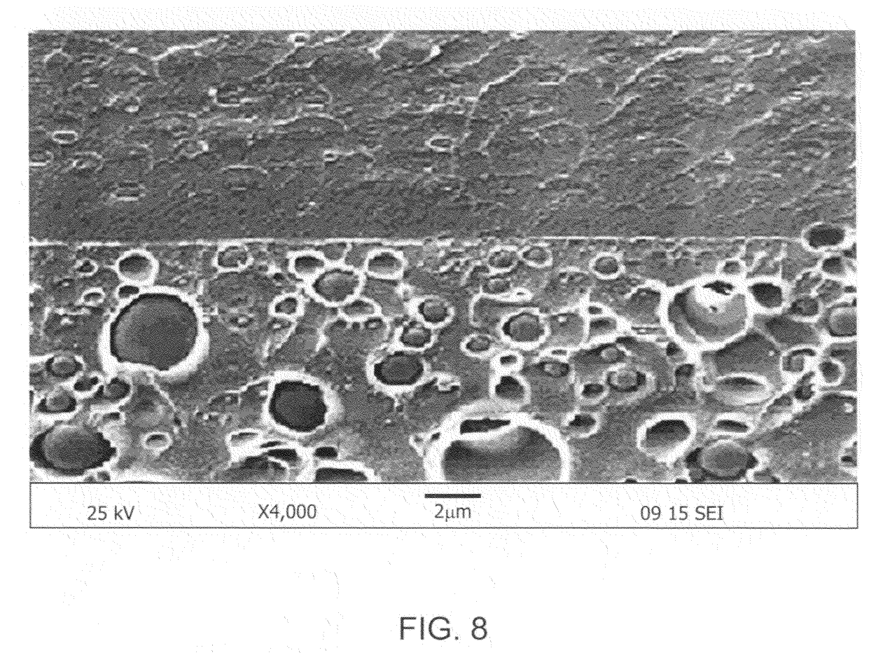

wherein, Blend 1 is a polymer blend membrane with co-continuous morphology prepared from 20 wt % of initial casting solution and freeze dried at a temperature of the Tg of the solution or lower; Blend 2 is a polymer blend membrane with co-continuous morphology prepared from 15 wt % of initial casting solution and freeze dried at a temperature of the Tg of the solution or lower; Blend 3 is a polymer blend membrane with two-layer morphology prepared from 15 wt % of initial casting solution and dried at a temperature of the Tg of the solution or higher; and Blend 4 is a polymer blend membrane with two-layer morphology prepared from 10 wt % of initial casting solution and dried at a temperature of the Tg of the solution or higher.

### DETAILED DESCRIPTION OF THE PREFERRED EMBODIMENTS

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

In one aspect, as discussed above, the present invention provides a polymer blend membrane comprising a highly sulfonated polysulfone copolymer and a nonsulfonated polysulfone copolymer. The highly sulfonated polysulfone copolymer is used for achieving high proton conductivity and the nonsulfonated polysulfone copolymer is used for improving methanol barrier property. Preferably, the highly sulfonated polysulfone copolymer has 60 mol % or more of disulfonated pendant groups to obtain 0.17 S/cm or higher in proton conductivity. More preferably, the highly sulfonated polysulfone copolymer has 60-80 mol % of disulfonated pendant groups to obtain 0.17-0.30 S/cm in proton conductivity. Morphology of the polymer blend membranes can be controlled by regulating phase separation process through varying drying condition and concentration of the casting solution.

In a preferred embodiment, a polymer blend membrane with co-continuous morphology is provided. The co-continuous morphology of polymer blend membrane can be prepared by capturing the phase separation at early stage of the spinodal decomposition. Suppression of the phase separation can be obtained, for example, by freeze-drying the polymer blend solution with a high concentration.

The co-continuous morphology can be formed, for example, by accelerating solvent removal such as using a solvent with a low boiling point, increasing the viscosity of the polymer solution, or lowering the drying temperature.

When the viscosity is increased and drying temperature is lowered near or below the Tg of the solution to restrict the phase separation, spinodal decomposition is frozen at the early stage and the co-continuous percolating structure is obtained. The size of the co-continuous phase is described by a wavelength marking the distance between the centers of the neighboring continuous phase, and the submicron sized (about 1 μm or less, or 0.5-0.6 μm) domain is observed.

In another preferred embodiment, a polymer blend membrane with two-layer morphology is provided. The polymer blend membrane with two-layer structure is composed of one layer having highly sulfonated polysulfone matrix and the other layer having nonsulfonated polysulfone matrix.

The polymer blend membrane with two-layer structure can be formed by maintaining the phase separation until later stage of the spinodal decomposition. For example, it can be formed by retarding solvent removal such as using solvent with a high boiling point, lowering the viscosity of the polymer casting solution or increasing the drying temperature.

The polymer blend membrane with two-layer structure can also be formed by the difference in specific gravity of the two component copolymers. Preferable difference in specific gravity between the two component copolymers is 0.01 or more. A more preferable difference is 0.01˜0.1.

According to preferred embodiments of the present invention, delamination of the two-layer structure is prevented by increased interfacial adhesion which is attained by in-situ formation of the two-layer structure during the phase separation.

Suitably, in an application to DMFC, membrane-electrode assembly (MEA) of the two-layer polyelectrolyte membranes may comprise the layer having the highly sulfonated polysulfone matrix with high proton conductivity which faces the cathode, and the layer having the nonsulfonated polysulfone matrix with low methanol permeability which faces the anode.

As the solvent is removed from blend solution by evaporation, liquid-liquid phase separation occurs and two-layered morphology is detected when the difference in specific gravity between the two components is significant. However, the difference in specific gravity between the sulfonated and nonsulfonated polysulfones causes sulfonated polysulfone liquid phase to settle to the bottom layer since the viscosity is low. After the formation of the two layers, further evaporation of the solvent causes the secondary phase separation in each layer and thus small domains are also detected in the layered structure.

The morphology of the blend membrane was observed by scanning electron microscopy and energy dispersive X-ray analysis (EDAX). The exchange of the cation from proton (—SO₃H) to potassium (—SO₃K) in the sulfonic acid groups of sulfonated poly sulfone copolymer was performed for the EDAX analysis to increase the contrast between the sulfonic acid group-rich sulfonated component region and the nonsulfonated component region with no sulfonic acid groups.

The two-layered structure was confirmed by the step change of the potassium profile in the EDAX analysis. Co-continuous morphology wherein both components were connected in a three-dimensional space was obtained by EDAX analysis which confirmed that potassium elements of sulfonic acid groups in the sulfonated polysulfone copolymer were evenly distributed throughout the membrane.

The proton conductivity of the membrane in a proton exchange membrane fuel cell is a critical parameter with respect to the evaluation of a fuel cell system. Specifically, a higher value of proton conductivity is required to achieve a higher power density. Methanol permeability is also one of the important membrane properties in DMFC applications since methanol crossover from the anode to the cathode leads to lower cell voltage and fuel efficiency due to the loss of the unreacted fuel. In order to apply a blend membrane to DMFC systems, not only proton conductivity and methanol permeability but also membrane selectivity should be considered. The selectivity can be defined as the following equation.

$$membrane selectivity = \frac{proton conductivity}{methanol permeability}$$

Selectivity change of blend membranes at different temperatures can be classified into two groups based on distinctive morphological characteristics such as two-layer morphology and co-continuous morphology of the membrane.

The preferred embodiments are further illustrated by the following non-limiting examples.

### EXAMPLE 1

### Polymer Blend Membranes Having Co-Continuous Morphology

Sulfonated poly(arylene ether sulfone) copolymer and nonsulfonated poly(ether sulfone) copolymer were blended with 1:1 weight based blend ratio in N,N-dimethylacetamide (DMAc). Initial casting concentration was from 20 wt % (Blend 1) to 15 wt % (Blend 2) and cast solution was freeze dried at −75° C. for 140 hours under vacuum condition and then the temperature was raised to 100° C. to remove the residual solvent completely.

According to scanning electron microscopy, the size of the co-continuous domain was less than 1 μm.

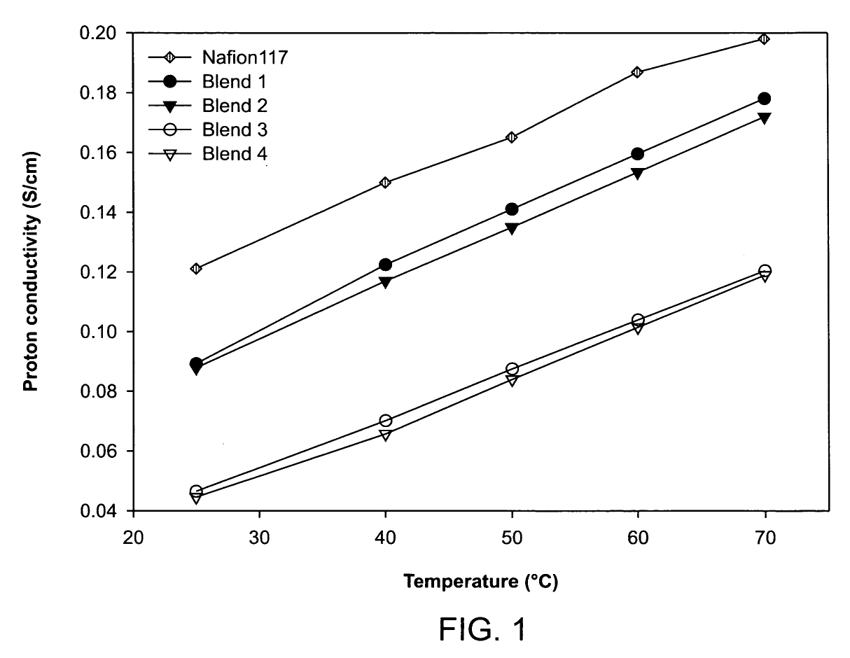

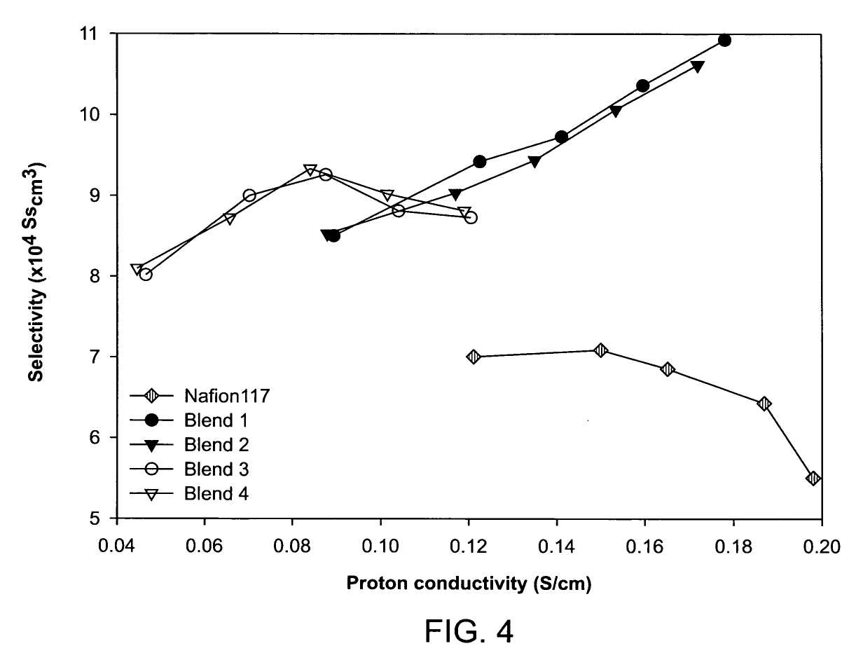

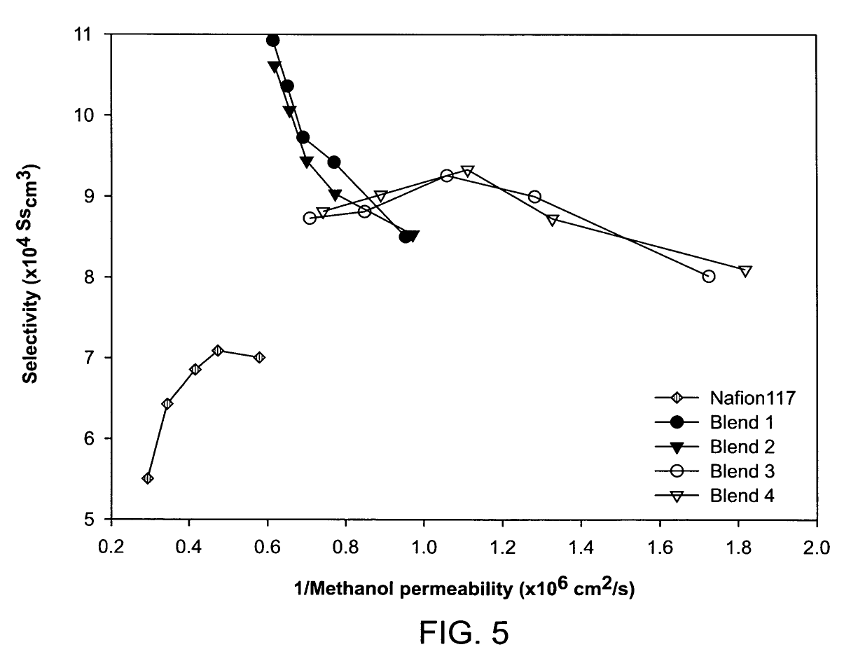

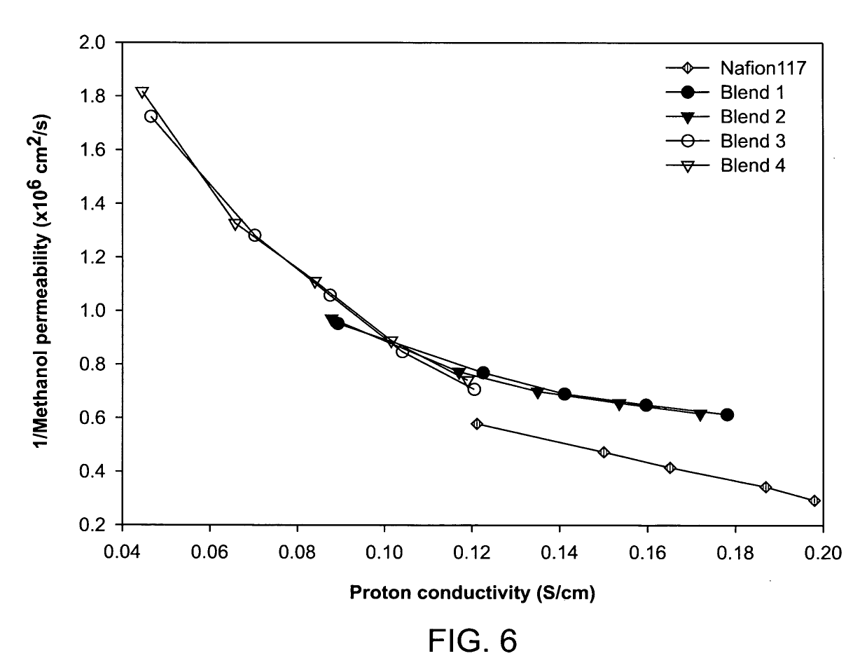

Well developed hydrophilic channels facilitated proton movement and hydrophobic network restricted the methanol crossover. Consequently, fuel leakage was effectively limited and membrane selectivity was maximized, and excellent selectivity was maintained even at a high temperature. Transport properties of the blend membranes measured at different temperature are shown in FIGS. 1-3. Proton conductivity, methanol permeability and membrane selectivity thereof are compared in FIGS. 4-6.

### EXAMPLE 2

### Polymer Blend Membranes Having Two-Layer Morphology

Sulfonated poly(arylene ether sulfone)copolymer and nonsulfonated poly(ether sulfone)copolymer were blended with 1:1 weight based blend ratio in N,N-dimethylacetamide (DMAc). Initial casting concentration was 15 wt % (Blend 3) to 10 wt % (Blend 4). Cast solution was dried at 80° C. under ambient atmosphere for 12 hours and then dried at 120° C. under vacuum for 24 hours to remove the residual solvent completely.

Two layered morphology was characterized through scanning electron microscopy and energy dispersive X-ray analysis.

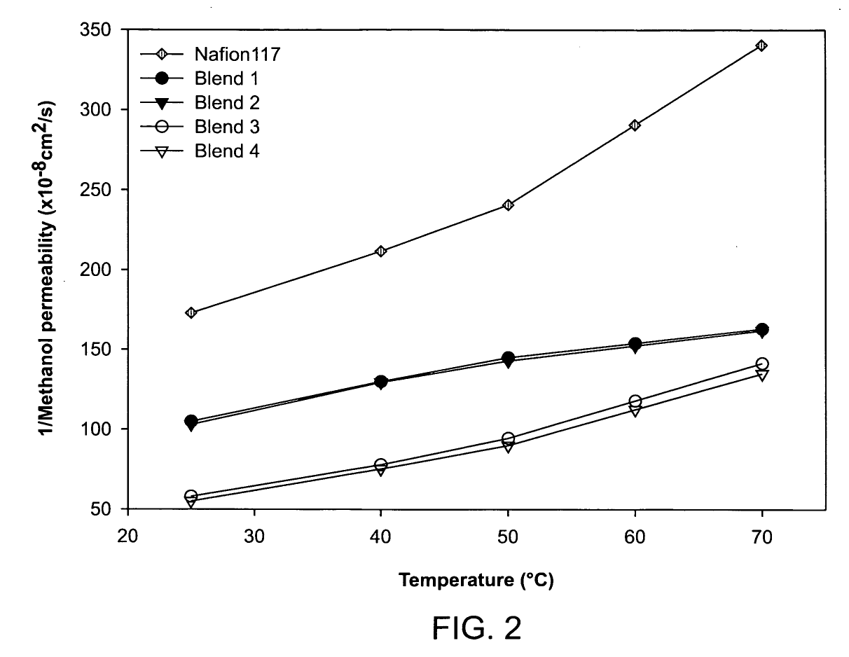

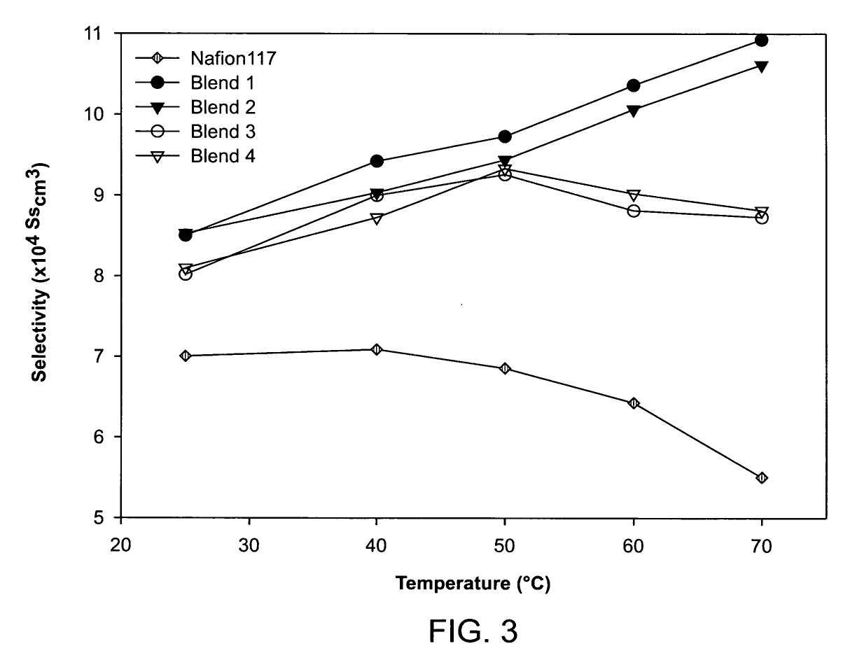

Even though the proton conductivity and membrane selectivity were not higher than those of co-continuous morphology as shown in FIGS. 1 and 3, nonsulfonated poly(ether sulfone)copolymer rich layer reduced the methanol crossover remarkably as shown in FIG. 2.

### EXAMPLE 3

### Preparation of DMFC

The cathode catalyst ink was prepared by mixing 20 wt % Pt/C, 5 wt % Nafion dispersion (DuPont), and isopropanol together. The catalyst loading on the anode side was 3 mg/cm² with PtRu black (1:1 a/o) and 5 wt % of Nafion solution. After the mixture was stirred and dispersed uniformly, catalyst ink was directly coated onto the carbon paper to form a catalyst layer. Both electrodes were dried at 70° C. for 1 hour and then the Nafion and isopropanol mixture (weight ratio was 1:3) was coated on the electrode surface. Finally, membrane electrode assembly with an active area of 3 cm² was fabricated by hot pressing at 125° C. and 100 atm. When the polymer blend membrane with two-layer morphology was applied to DMFC application, the layer having the highly sulfonated polysulfone matrix with a high proton conductivity was faced to the cathode, and the layer having the nonsulfonated polysulfone matrix with a low methanol permeability was faced to the anode.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for preparing a polymer blend membrane for fuel cell application, the method comprising the steps of:
(a) blending a highly sulfonated polysulfone copolymer and a nonsulfonated polysulfone copolymer in a solvent;
(b) casting the solution; and
(c) removing the solvent from the cast solution.

2. The method of claim 1, wherein the highly sulfonated polysulfone copolymer has at least 60 mol % of disulfonated pendant groups to obtain at least 0.17 S/cm of proton conductivity.

3. The method of claim 2, wherein the highly sulfonated polysulfone copolymer has 60-80 mol % of disulfonated pendant groups to obtain 0.17-0.30 S/cm of proton conductivity.

4. The method of claim 1, wherein the step (a) is carried out by blending sulfonated poly(arylene ether sulfone)copolymer and nonsulfonated poly(ether sulfone)copolymer with 1:1 weight based blend ratio in N,N-dimethylacetamide (DMAc).

5. The method of claim 2 further comprising the step of suppressing phase separation at early stage of spinodal decomposition.

6. The method of claim 5, wherein the step of suppressing phase separation is carried out by freeze-drying.

7. The method of claim 5, wherein the removal of the solvent is accelerated by using a solvent with low boiling point, increasing the viscosity of the solution, or lowering drying temperature.

8. The method of claim 2 further comprising the step of maintaining phase separation until late stage of spinodal decomposition.

9. The method of claim 8, wherein the removal of the solvent is delayed by using a solvent with high boiling point, lowering the viscosity of the solution, or increasing drying temperature.

10. A polymer blend membrane prepared by the method of claim 1.

11. A polymer blend membrane prepared by the method of claim 5.

12. The polymer blend membrane of claim 11 which has co-continuous morphology.

13. A polymer blend membrane prepared by the method of claim 8.

14. The polymer blend membrane of claim 13 which has two-layer morphology.

15. The polymer blend membrane of claim 14, wherein the two-layer morphology is prevented from being delaminated by interfacial adhesion which has been increased by in-situ formation of the two-layer structure.

16. The polymer blend membrane of claim 14, wherein the difference in specific gravity is at least 0.01.

17. A fuel cell comprising the polymer blend membrane of claim 10.

18. A fuel cell comprising the polymer blend membrane of claim 12.

19. A fuel cell comprising the polymer blend membrane of claim 14.

20. The fuel cell of claim 19, wherein the two-layer morphology membrane comprises a first layer having the highly sulfonated polysulfone and a second layer having the nonsulfonated polysulfone, and the first layer faces the cathode of the fuel cell and the second layer faces the anode.
